(19) United States
(12) Patent Application Publication
(10) Pub. No.: US 2022/0353131 A1
(43) Pub. Date: Nov. 3, 2022

(54) UPLINK BEAM CONTINUATION FOR DOWNLINK BEAM FAILURE RECOVERY

(71) Applicant: QUALCOMM Incorporated, San Diego, CA (US)

(72) Inventors: Mostafa Khoshnevisan, San Diego, CA (US); Yitao Chen, San Diego, CA (US); Jing Sun, San Diego, CA (US); Xiaoxia Zhang, San Diego, CA (US)

(21) Appl. No.: 17/244,777

(22) Filed: Apr. 29, 2021

(51) Int. Cl. H04L 12/24; H04L 5/00; H04W 72/04; H04W 52/24

(52) U.S. Cl. CPC H04L 41/0654; H04L 5/0048; H04L 41/0816; H04W 72/0413; H04W 52/242; H04W 74/0833

(57) ABSTRACT

Methods, systems, and devices for wireless communications are described. A user equipment (UE) may communicate with a base station in a wireless communications system using downlink beams and uplink beams. A UE may determine whether to maintain or change an uplink beam of the UE after a downlink beam failure. The UE may receive control signaling indicating a configuration for uplink beam management for use in response to a downlink beam failure detection in a deployment configuration where uplink beams of the UE may be decoupled from downlink beams of the UE. The UE may perform a downlink beam failure recovery (BFR) procedure based on a downlink beam failure of a downlink beam of the UE. The UE may reconfigure an uplink beam based on the configuration and the downlink BFR procedure.

### FIELD OF TECHNOLOGY

The following relates to wireless communications, including uplink beam continuation for downlink beam failure recovery.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may receive signals from a base station using downlink beams of the UE. In some cases, the UE may experience a beam failure of the downlink beam used to receive the signals. The UE may perform a beam failure recovery (BFR) procedure, and the UE may update downlink beams and uplink beams for communication with a base station.

### SUMMARY

The described techniques relate to improved methods, systems, devices, and apparatuses that support uplink beam continuation for downlink beam failure recovery. Generally, the described techniques provide for a UE determining whether to maintain or change uplink beams after a downlink beam failure. The UE may receive control signaling indicating a configuration for uplink beam management for use in response to a downlink beam failure detection in a deployment configuration where uplink beams of the UE may be decoupled from downlink beams of the UE. The UE may perform a downlink beam failure recovery (BFR) procedure based on a downlink beam failure of a downlink beam of the UE. The UE may reconfigure an uplink beam based on the configuration and the downlink BFR procedure.

A method is described. The method may include receiving control signaling indicating a configuration for uplink beam management for use in response to a downlink beam failure detection in a deployment configuration where uplink beams of the UE are decoupled from downlink beams of the UE, performing a downlink BFR procedure based on a downlink beam failure of a downlink beam of the UE, and reconfiguring an uplink beam based on the configuration and the downlink BFR procedure.

An apparatus is described. The apparatus may include a processor, memory coupled with the processor, and instructions stored in the memory. The instructions may be executable by the processor to cause the apparatus to receive control signaling indicating a configuration for uplink beam management for use in response to a downlink beam failure detection in a deployment configuration where uplink beams of the UE are decoupled from downlink beams of the UE, perform a downlink BFR procedure based on a downlink beam failure of a downlink beam of the UE, and reconfigure an uplink beam based on the configuration and the downlink BFR procedure.

Another apparatus is described. The apparatus may include means for receiving control signaling indicating a configuration for uplink beam management for use in response to a downlink beam failure detection in a deployment configuration where uplink beams of the UE are decoupled from downlink beams of the UE, means for performing a downlink BFR procedure based on a downlink beam failure of a downlink beam of the UE, and means for reconfiguring an uplink beam based on the configuration and the downlink BFR procedure.

A non-transitory computer-readable medium storing code is described. The code may include instructions executable by a processor to receive control signaling indicating a configuration for uplink beam management for use in response to a downlink beam failure detection in a deployment configuration where uplink beams of the UE are decoupled from downlink beams of the UE, perform a downlink BFR procedure based on a downlink beam failure of a downlink beam of the UE, and reconfigure an uplink beam based on the configuration and the downlink BFR procedure.

Some examples of the method, apparatuses, and non-transitory computer-readable medium described herein may further include operations, features, means, or instructions for reconfiguring the uplink beam based on a rule indicated by the configuration.

Some examples of the method, apparatuses, and non-transitory computer-readable medium described herein may further include operations, features, means, or instructions for determining that the uplink beam corresponds to a downlink reference signal associated with the detected downlink beam failure and resetting the uplink beam based on the determining and the rule.

Some examples of the method, apparatuses, and non-transitory computer-readable medium described herein may further include operations, features, means, or instructions for resetting the uplink beam to a beam used for a previous random access transmission.

Some examples of the method, apparatuses, and non-transitory computer-readable medium described herein may further include operations, features, means, or instructions for resetting the uplink beam to a new candidate beam.

Some examples of the method, apparatuses, and non-transitory computer-readable medium described herein may further include operations, features, means, or instructions for determining that the uplink beam corresponds to an uplink reference signal and maintaining the uplink beam for uplink control channel transmissions after performing the downlink BFR procedure based on the determining and the rule.

In some examples of the method, apparatuses, and non-transitory computer-readable medium described herein, the rule indicated by the configuration indicates whether to reset the uplink beam based on a random access channel transmission beam used in the downlink BFR procedure.

Some examples of the method, apparatuses, and non-transitory computer-readable medium described herein may further include operations, features, means, or instructions for receiving an indication of a path loss threshold.

Some examples of the method, apparatuses, and non-transitory computer-readable medium described herein may further include operations, features, means, or instructions for identifying a candidate beam for the uplink beam based on the downlink BFR procedure, determining that a path loss measurement of the candidate beam exceeds the path loss threshold, and maintaining the uplink beam for uplink control channel transmissions after performing the downlink BFR procedure based on the determining and the rule.

Some examples of the method, apparatuses, and non-transitory computer-readable medium described herein may further include operations, features, means, or instructions for identifying a candidate beam for the uplink beam based on the downlink BFR procedure, determining that a path loss measurement of the candidate beam fails to satisfy a path loss threshold, and resetting the uplink beam to the candidate beam based on the determining and the rule.

In some examples of the method, apparatuses, and non-transitory computer-readable medium described herein, the rule indicates whether the UE may be to reconfigure an uplink power control configuration of the uplink beam, an uplink path loss value of the uplink beam, or both.

Some examples of the method, apparatuses, and non-transitory computer-readable medium described herein may further include operations, features, means, or instructions for determining that the uplink path loss value may be based on path loss reference signal measurements corresponding to a path loss reference signal identifier corresponding to the uplink beam and resetting the uplink path loss value based on a path loss value corresponding to a new candidate beam.

Some examples of the method, apparatuses, and non-transitory computer-readable medium described herein may further include operations, features, means, or instructions for adjusting a TPC command of the uplink beam.

Some examples of the method, apparatuses, and non-transitory computer-readable medium described herein may further include operations, features, means, or instructions for receiving signaling indicating the TPC command, where the signaling includes downlink control information or a random access response message.

In some examples of the method, apparatuses, and non-transitory computer-readable medium described herein, adjusting the TPC command may include operations, features, means, or instructions for determining whether to adjust a delta power ramp-up parameter corresponding to the TPC command.

Some examples of the method, apparatuses, and non-transitory computer-readable medium described herein may further include operations, features, means, or instructions for determining whether a random access transmission may be transmitted using a receive beam corresponding to a new candidate beam, where determining whether to adjust the delta power ramp-up parameter may be based on the random access transmission.

In some examples of the method, apparatuses, and non-transitory computer-readable medium described herein, the control signaling indicating the configuration for the uplink beam management includes RRC signaling corresponding to a serving cell configuration, a bandwidth part configuration, a BFR configuration, an uplink control channel resource, or a combination thereof.

In some examples of the method, apparatuses, and non-transitory computer-readable medium described herein, the control signaling indicating the configuration for the uplink beam management includes downlink control information signaling corresponding to the downlink BFR procedure, and the downlink control information includes a downlink control channel in a recovery search space identifier, an uplink grant, or a control channel reception.

In some examples of the method, apparatuses, and non-transitory computer-readable medium described herein, the control signaling indicating the configuration for the uplink beam management includes a random access response message, a medium access control channel element signal, or a combination thereof.

Some examples of the method, apparatuses, and non-transitory computer-readable medium described herein may further include operations, features, means, or instructions for transmitting signaling indicating a capability of the UE to reconfigure the uplink beam based on the configuration and the downlink BFR procedure.

Some examples of the method, apparatuses, and non-transitory computer-readable medium described herein may further include operations, features, means, or instructions for transmitting an uplink control channel transmission using the uplink beam.

A method is described. The method may include transmitting, to a UE, control signaling indicating a configuration for uplink beam management for use in response to a downlink beam failure detection in a deployment configuration where uplink beams of the UE are decoupled from downlink beams of the UE, identifying a downlink BFR procedure based on a downlink beam failure of a downlink beam of the UE, and receiving an uplink signal from the UE on an uplink beam based on the configuration and the downlink BFR procedure.

An apparatus is described. The apparatus may include a processor, memory coupled with the processor, and instructions stored in the memory. The instructions may be executable by the processor to cause the apparatus to transmit, to a UE, control signaling indicating a configuration for uplink beam management for use in response to a downlink beam failure detection in a deployment configuration where uplink beams of the UE are decoupled from downlink beams of the UE, identify a downlink BFR procedure based on a downlink beam failure of a downlink beam of the UE, and receive an uplink signal from the UE on an uplink beam based on the configuration and the downlink BFR procedure.

Another apparatus is described. The apparatus may include means for transmitting, to a UE, control signaling indicating a configuration for uplink beam management for use in response to a downlink beam failure detection in a deployment configuration where uplink beams of the UE are decoupled from downlink beams of the UE, means for identifying a downlink BFR procedure based on a downlink beam failure of a downlink beam of the UE, and means for receiving an uplink signal from the UE on an uplink beam based on the configuration and the downlink BFR procedure.

A non-transitory computer-readable medium storing code is described. The code may include instructions executable by a processor to transmit, to a UE, control signaling indicating a configuration for uplink beam management for use in response to a downlink beam failure detection in a deployment configuration where uplink beams of the UE are decoupled from downlink beams of the UE, identify a downlink BFR procedure based on a downlink beam failure of a downlink beam of the UE, and receive an uplink signal from the UE on an uplink beam based on the configuration and the downlink BFR procedure.

Some examples of the method, apparatuses, and non-transitory computer-readable medium described herein may further include operations, features, means, or instructions for receiving the uplink signal from the UE, where the uplink signal may be transmitted using a new candidate beam of the UE.

Some examples of the method, apparatuses, and non-transitory computer-readable medium described herein may further include operations, features, means, or instructions for receiving the uplink signal from the UE, where the uplink signal may be transmitted using a beam used for a previous random access transmission of the UE.

Some examples of the method, apparatuses, and non-transitory computer-readable medium described herein may further include operations, features, means, or instructions for receiving signaling indicating a capability of the UE to reconfigure the uplink beam based on the configuration and a downlink BFR procedure.

Some examples of the method, apparatuses, and non-transitory computer-readable medium described herein may further include operations, features, means, or instructions for receiving an uplink control channel transmission from the UE using the uplink beam.

### BRIEF DESCRIPTION OF THE DRAWINGS

FIG. 1 illustrates an example of a wireless communications system that supports uplink beam continuation for downlink beam failure recovery in accordance with aspects of the present disclosure.

FIG. 2 illustrates an example of a wireless communications system that supports uplink beam continuation for downlink beam failure recovery in accordance with aspects of the present disclosure.

FIG. 3 illustrates an example of a process flow that supports uplink beam continuation for downlink beam failure recovery in accordance with aspects of the present disclosure.

FIGS. 4 and 5 show block diagrams of devices that support uplink beam continuation for downlink beam failure recovery in accordance with aspects of the present disclosure.

FIG. 6 shows a block diagram of a communications manager that supports uplink beam continuation for downlink beam failure recovery in accordance with aspects of the present disclosure.

FIG. 7 shows a diagram of a system including a device that supports uplink beam continuation for downlink beam failure recovery in accordance with aspects of the present disclosure.

FIGS. 8 and 9 show block diagrams of devices that support uplink beam continuation for downlink beam failure recovery in accordance with aspects of the present disclosure.

FIG. 10 shows a block diagram of a communications manager that supports uplink beam continuation for downlink beam failure recovery in accordance with aspects of the present disclosure.

FIG. 11 shows a diagram of a system including a device that supports uplink beam continuation for downlink beam failure recovery in accordance with aspects of the present disclosure.

FIGS. 12 through 15 show flowcharts illustrating methods that support uplink beam continuation for downlink beam failure recovery in accordance with aspects of the present disclosure.

### DETAILED DESCRIPTION

Some wireless communications systems may include communication devices, such as user equipment (UE), base stations (for example, an eNodeB (eNB), a next-generation NodeB or a giga-NodeB, any of which may be referred to as a gNB, a parent node, or some other base station), and uplink nodes (for example, a repeater node, a daughter node, or any other device configured with uplink capabilities). The UE may communicate with the base station using downlink beams and uplink beams. The UE may receive signals from the base station using downlink beams of the UE, and may transmit signals to the base station using uplink beams of the UE.

In some cases, the UE may experience a beam failure of a downlink beam of the UE. The beam failure may be based on measurements of beam reference signals falling below a threshold. In these cases, the UE may perform a beam failure recovery (BFR) procedure, involving identifying new candidate beams for use. The BFR procedure may generally include the UE selecting new uplink beams and new downlink beams, although, in this case, the failure may have only been experienced on a downlink beam.

In some cases, the UE may also operate in an uplink dense deployment situation, where an uplink transmission reception point (TRP) is different from a downlink TRP, or when there may be additional carriers for a supplemental uplink (SUL) configuration. These may be examples of uplink dense deployment systems.

In an uplink dense deployment system, the uplink beams of the UE may be decoupled from (e.g., may be pointing in a different direction or may otherwise be different than) the downlink beams of the UE. For example, the UE may receive signals from the base station via a downlink beam and may transmit signals to an uplink node via an uplink beam. In some cases, the uplink node may be separate from (e.g., may not be co-located with) the base station. As such, the uplink node may transmit (or forward) the signals from the UE to the base station, for example, using a backhaul link. Additionally or alternatively, the UE may communicate with the base station via a SUL carrier (e.g., using transmissions according to carrier configurations without downlink portions). In some examples, a beam used for an uplink transmission in a SUL carrier may point in a different direction than a downlink beam used by the UE to receive transmissions from the base station. Thus, in an uplink dense deployment system or a system using SUL carriers, using an uplink beam corresponding to a downlink beam may result in lower communication quality and, in some cases, in a failure to receive the random access message at the base station.

In these cases, when a UE experiences a downlink beam failure, it may not necessarily mean that the UE would need to change the uplink beam as well, as the uplink beam may not have failed and may not be at risk of failing, as the uplink beam may be decoupled from the downlink beam, and may be used differently or point in a different direction from the uplink beam. However, BFR procedures include changing uplink beam configurations when the UE experiences a downlink beam failure.

Thus, the UE may determine whether to change an uplink beam when the UE experiences a downlink beam failure. The UE may maintain a selected uplink beam, or could change the uplink beam to a candidate beam, or a beam used for a previous transmission. Additionally or alternatively, the UE may also determine whether to maintain or change power parameters of a selected uplink beam, including power control power ramp-up, and other power parameters.

The UE may receive control signaling from a base station that may be used by the UE in an uplink dense scenario (e.g., when uplink beams may be decoupled from downlink beams) in cases of a beam failure. The configuration may include guidance for how and whether a UE should change an uplink beam after performing a BFR process for a downlink beam. For example, if the uplink beam corresponds to a reference signal that also corresponds to a failed reference signal, then the UE can change the beam. The UE may also maintain the beam if the reference signal is not associated with a failure. In other examples, the UE may change or maintain the beam based on whether a previous random access transmission was associated with a failed beam. The UE may also determine whether to change or maintain power control and path loss parameters of the uplink beam, based on the configuration received from the base station.

Aspects of the disclosure are initially described in the context of wireless communications systems. Aspect of the disclosure are then described in the context of process flows. Aspects of the disclosure are further illustrated by and described with reference to apparatus diagrams, system diagrams, and flowcharts that relate to uplink beam continuation for downlink beam failure recovery.

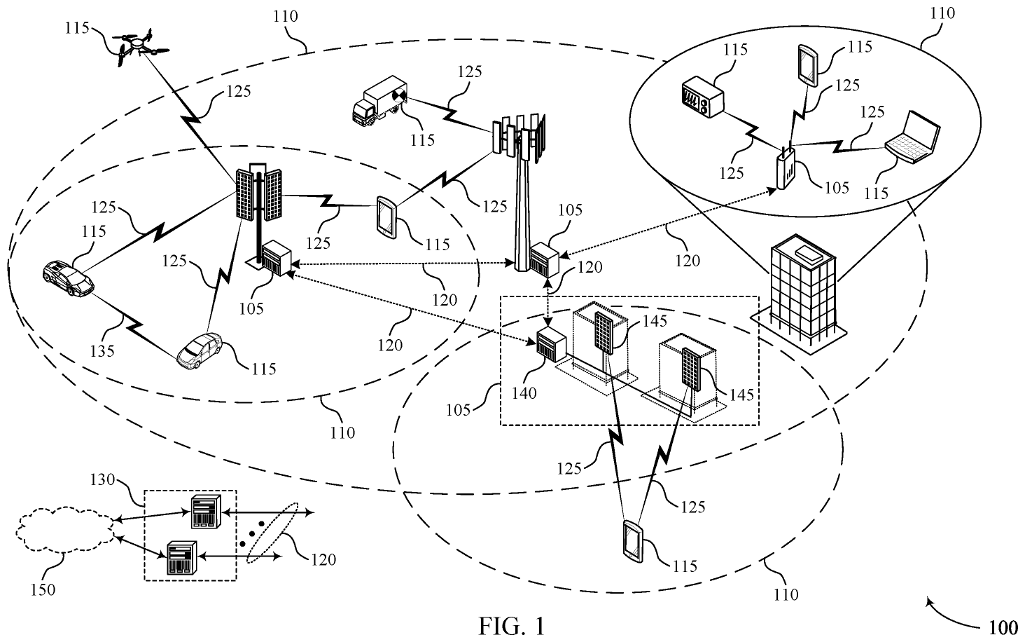

FIG. 1 illustrates an example of a wireless communications system 100 that supports uplink beam continuation for downlink beam failure recovery in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may communicate with a base station 105 using downlink beams and uplink beams of the UE 115. The UE 115 may determine whether to maintain or change an uplink beam of the UE 115 after a downlink beam failure. The UE 115 may receive, from a base station 105, control signaling indicating a configuration for uplink beam management for use in response to a downlink beam failure detection in a deployment configuration where uplink beams of the UE 115 may be decoupled from downlink beams of the UE 115. The UE 115 may perform a downlink BFR procedure based on a downlink beam failure of a downlink beam of the UE 115. The UE 115 may reconfigure (e.g., change or maintain) an uplink beam based on the configuration and the downlink BFR procedure.

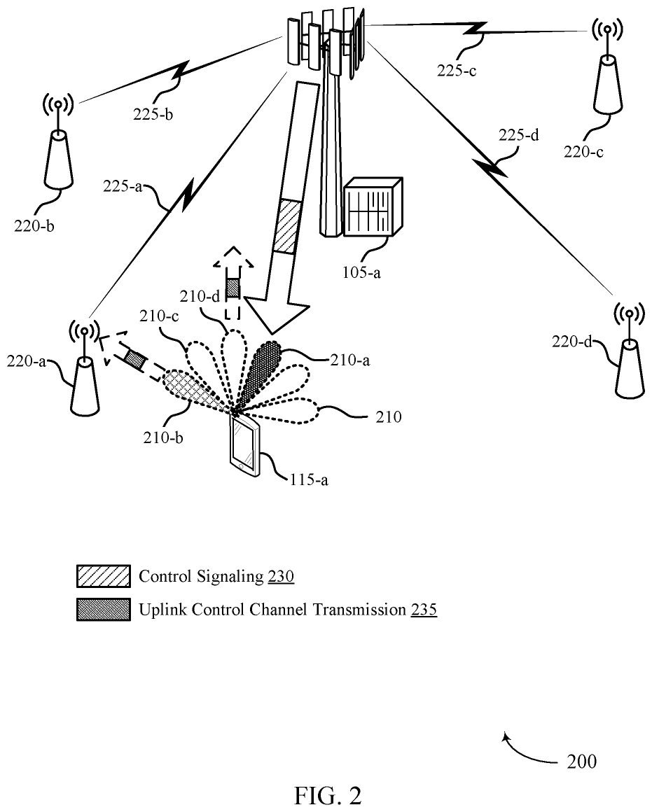

FIG. 2 illustrates an example of a wireless communications system 200 that supports uplink beam continuation for downlink beam failure recovery in accordance with aspects of the present disclosure. Wireless communications system 200 may include communications devices such as a base station 105-a and a UE 115-a which may be examples of base stations 105 and UEs 115 respectively as described with reference to FIG. 1. In some cases, wireless communications system 200 may be referred to as an uplink dense deployment system and may include one or more uplink nodes 220 which may be (or may otherwise support functionality for) repeater nodes, daughter nodes, or any other device configured with uplink capabilities.

In some cases, the UE 115-a may communicate with the base station 105-a using one or more beams 210. For example, the base station 105-a may transmit downlink signals to the UE 115-a and the UE may receive the downlink signals using beam 210-a (e.g., a receive beam 210-a or a downlink beam 210-a). In some cases, the UE 115-a may transmit uplink signals to the base station 105-a directly, via an uplink beam 210 or a transmit beam 210, such as a beam that corresponds to (e.g., has a same beam direction as) beam 210-a (e.g., which may in some cases be represented by beam 210-a). In other cases, the UE 115-a may transmit uplink signals to an uplink node 220, such as uplink node 220-a, for example, using beam 210-b. In such cases, the uplink node 220-a may transmit (or relay) the uplink signals to the base station 105-a using one or more communication links 225 (e.g., wireless or wired communication links 225) which may be equivalently referred to as backhaul links 225.

In some cases, UE 115-a and base station 105-a may communicate in the uplink via one or more uplink nodes 220 (e.g., in an uplink dense deployment scenario). In such cases, UE 115-a may transmit uplink signals to an uplink receive point, which may be represented by an uplink node 220 (e.g., uplink node 220-a). The uplink nodes 220 may be connected to base station 105-a (e.g., a macro node) via backhaul links 225 (e.g., wired or wireless links), such that one or more uplink nodes 220 may receive the uplink signals and/or channels from UE 115-a and forward associated uplink data or uplink information to base station 105-a (e.g., transmit an indication of the uplink data or information, such as via the backhaul link 225). Downlink signals and/or channels may be transmitted to UE 115-a from base station 105-a (e.g., a macro node, serving cell, serving base station 105), which may represent a different communication node (e.g., at a different location) than any uplink nodes 220 used for uplink communications.

An uplink dense deployment scenario as described herein may improve uplink coverage and/or capacity. For example, using one or more uplink nodes 220 for communications between UE 115-a and base station 105-a may reduce uplink path loss (e.g., among other examples). The reduction in path loss may increase uplink communication speed and throughput, which may in turn reduce a bottlenecking effect for the uplink communications (e.g., as compared to downlink communications). Additionally or alternatively, uplink dense deployment may reduce deployment cost and complexity for network entities (e.g., for uplink nodes 220), while increasing coverage, because the uplink nodes 220 may not be configured to transmit downlink signals or perform configurations. For example, each uplink node 220 may be configured to receive uplink signals (e.g., from UE 115-a) and send the uplink signals to base station 105-a (e.g., with or without some processing).

In some cases, UE 115-a and base station 105-a may communicate in the uplink via a SUL carrier. In such cases, UE 115-a may be configured with two uplink carriers for one downlink carrier of a same serving cell, where uplink transmissions on the two uplink carriers may not be simultaneous (e.g., may never be simultaneous). One of the uplink carriers may be configured as SUL (e.g., such that the other uplink carrier may be a non-SUL or normal uplink (NUL) carrier), and UE 115-a may choose which uplink carrier to use for uplink transmissions. In one example, UE 115-a may be configured with a TDD band (e.g., TDD uplink carrier) and SUL carrier, such that UE 115-a may transmit uplink information on either the TDD band (e.g., non-SUL or NUL carrier) or on the SUL carrier.

In cases where UE 115-a communicates with base station 105-a in the uplink via an uplink node 220 (e.g., uplink node 220-a), uplink transmit beams 210 may be associated with the uplink node 220 (e.g., and not with base station 105-a). Similarly, in cases where UE 115-a communicates with base station 105-a using a SUL carrier, uplink transmit beams 210 for the SUL carrier may not be associated with any corresponding beams 210 for the associated downlink carrier. As such, when UE 115-a communicates in the uplink via an uplink node 220, or via a SUL carrier, a beam correspondence may not exist between downlink and uplink beams 210. Thus, uplink and downlink beams 210 of UE 115-a may be decoupled.

In some cases, UE 115-a may experience a beam failure on a downlink beam, such as downlink beam 210-a. The beam failure may be detected based on a reference signal associated with the beam falling below a threshold. UE 115-a may perform a BFR procedure. In many cases, the BFR procedure may include identifying new candidate downlink and uplink beams, although the uplink beam (e.g., uplink beam 210-b) does not correspond to the downlink beam (e.g., downlink beam 210-a), and uplink beam 210-b may not have experienced a failure. Thus, selecting new beams for both uplink and downlink may be inefficient and unnecessary, and may decrease communications quality.

UE 115-a may receive control signaling 230 from base station 105-a. Control signaling 230 may include a configuration for uplink beam management that UE 115-a is to use in response to a downlink beam failure recovery procedure in an uplink dense deployment scenario. This configuration may include an indication for UE 115-a to continue to use uplink beam 210-b or an uplink beam transmit power after completion of a BFR procedure. Control signaling 230 including the configuration information may be transmitted in a RRC configuration as part of a serving cell BWP configuration or a BFR configuration. Or, the RRC signaling may be configured per uplink resource (e.g., physical uplink control channel (PUCCH) resource) or per group of uplink (e.g., PUCCH) resources. Control signaling 230 including the configuration information may also be indicated through downlink control information (DCI) that may be considered responsive to the BFR procedure performed by UE 115-a. The DCI may include a physical downlink control channel (PDCCH) in a recovery search space identifier for Case 1 BFR; an indication of an uplink grant scheduling a transmission for a same HARQ process as a physical uplink shared channel (PUSCH) transmission carrying a MAC-CE, which may be considered as a BFR response for a case 2 BFR; or a PDCCH that indicates the completion of the contention-based random access procedure for Case 3 BFR. Configuration signaling 230 may also be indicated in a random access response (RAR) message for a Case 3 BFR, or through a MAC-CE. Additionally or alternately, UE 115-a may indicate a capability of UE 115-a to reconfigure the uplink beam based on receiving control signaling 230 including the configuration information.

The control signaling 230 may indicate a rule which UE 115-a may use to determine whether to maintain or change the uplink beam 210-b. The rule may be applied or checked for each uplink resource (e.g., each PUCCH resource). A first part of the rule may be that if the previously configured or indicated uplink beam 210-b for the given uplink resource refers to a downlink reference signal (e.g., SSB or CSI-RS), then UE 115-a may reset the uplink beam 210-b to an uplink beam used for a last random access channel transmission, or reset the uplink beam 210-b to a candidate receive beam selected as part of a downlink BFR procedure.

In a second case, the rule may indicate that if the previously configured or indicated uplink beam 210-b for the given uplink resource refers to an uplink reference signal (e.g., a SRS), then UE 115-a may continue to transmit with the configured or indicated uplink beam. In other words, UE 115-a may not update the uplink beam 210-a after the downlink BFR procedure.

The rule may further be based on the type of BFR performed. The rule may indicate that for a Case 2 BFR, UE 115-a may maintain the uplink beam 210-b and not reset the beam after the downlink BFR procedure. In Case 1 or Case 3 BFR, the rule may indicate that whether UE 115-a is to update or reset the uplink beam 210-b may be based on a previous PRACH transmission. In a first case, the rule may indicate that when a PRACH was transmitted using a receive beam of a new candidate beam, then UE 115-a should not reset the transmit beam. In a second case, if the PRACH was transmitted using a beam different than a receive beam of a new candidate beam, then UE 115-a may change uplink beam 210-b to a beam used in the previous PRACH transmission.

Additionally or alternatively, the configuration and rule may also indicate whether UE 115-a is to use previously configured transmit power control (TPC) parameters, or update the parameters. the parameters may include an initial power, a path loss, a closed loop index 1, and other power parameters.

UE 115-a may determine whether the reset a path loss value based on a rule that is applied per uplink resource. In a first case, if the path loss is computed based on path loss reference signal measurements (e.g., SSB or CSI-RS) based on an indicated path loss reference signal identifier for the uplink (e.g., PUCCH) resource, then UE 115-a may reset the path loss reference signal to a reference signal associated with a new candidate beam. In a second case, if the path loss is based on an indicated path loss value or a path loss offset value for the uplink resource, then UE 115-a may continue to determine that transmit power based on the indicated path loss value or a path loss offset value.

UE 115-a may also determine closed loop power control adjustment state based on the rule. UE 115-a may determine whether to add a delta power ramp-up or TPC command, or both, to the current power control adjustment state, without resetting. The closed loop power control adjustment state may be given by the following function g:

(g_{b,f,c}(i,l)=g_{b,f,c}(i−i₀,l)+ΔP_{rampup,b,f,c}+δ_{b,f,c})

For Case 1 BFR, the TPC command may be provided in DCI (e.g., PDCCH in a recovery search space identifier). For Case 3 PFR, the TPC command may be given in a RAR message. The rule may indicate that whether to add the delta power ramp-up to the current state may depend on PRACH transmission. In a first case, if a PRACH is transmitted using the receive beam of a candidate beam (e.g., the PRACH was targeted toward base station 105-a), UE 115-a may determine not to add the delta power ramp-up. In a second case, if a PRACH was transmitted using a beam different than the new candidate receive beam (e.g., the PRACH was transmitted toward uplink node 220-a), then UE 115-a may add the delta power ramp-up to uplink transmissions with uplink beam 210-a. If the delta power ramp-up is applied, it may be applied whether or not l=0 or 1, as the closed loop index may not be reset.

Additionally or alternatively, UE 115-a may receive an indication of a path loss threshold from base station 105-a. UE 115-a may measure a path loss of a new identified uplink candidate beam. If the path loss of the identified beam exceeds the path loss threshold, then UE 115-a may determine not to reset the uplink beam or the transmit power. The path loss exceeding the path loss threshold may indicate that the downlink beam may not have a high enough quality to use for the uplink beam, so UE 115-a may continue to use a previous uplink beam, rather than updating to the new identified beam.

If the path loss of the candidate beam does not exceed the indicated path loss threshold, then UE 115-a may reset the uplink beam, or the transmit power, or both, as this indicates that for both uplink and downlink, the newly identified beam is of high enough quality for both transmissions.

UE 115-a may transmit uplink control channel transmission 235, including PUCCH transmissions, to base station 105-a (e.g., uplink node 220-a), based on the configuration and rule receive in control signaling 230.

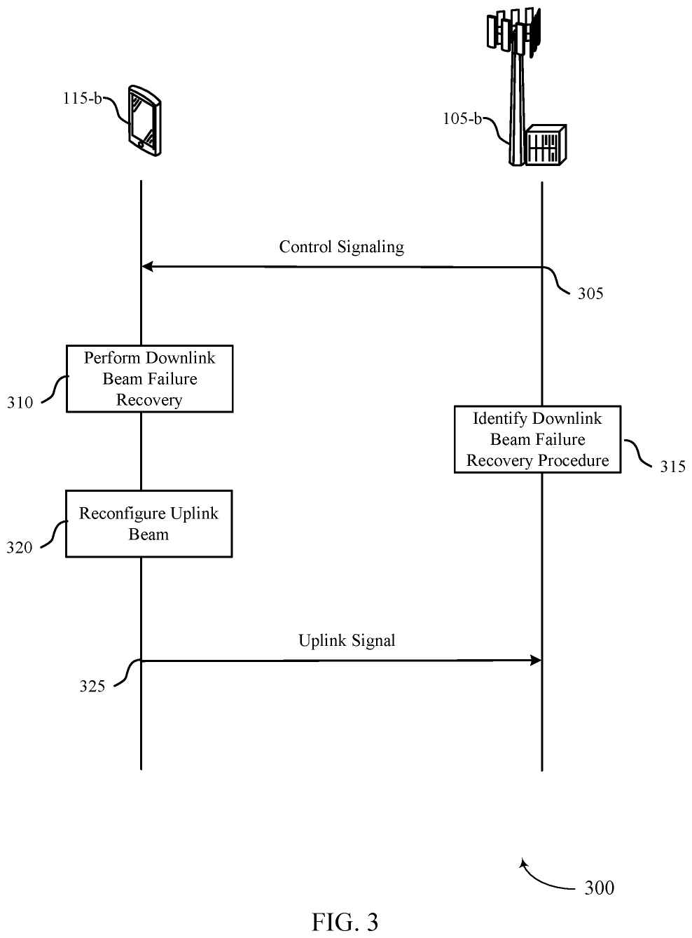

FIG. 3 illustrates an example of a process flow 300 that supports uplink beam continuation for downlink BFR in accordance with aspects of the present disclosure. Process flow 300 includes UE 115-b, which may be an example of a UE 115 as described with respect to FIGS. 1 and 2. Process flow 300 also includes base station 105-b, which may be an example of a base station 105 as described with respect to FIGS. 1 and 2. UE 115-b and base station 105-b may communicate in a wireless communications system by transmitting uplink and downlink signals. UE 115-b may operate according to a beamforming configuration, and may transmit and receive signals using one or more beams.

At 305, UE 115-b may receive control signaling indicating configuration for uplink beam management for use in response to a downlink beam failure detection in a deployment configuration where uplink beams of UE 115-b may be coupled from downlink beams of UE 115-b. The control signaling may include RRC signaling corresponding to a serving cell configuration, a BWP configuration, a BFR configuration, an uplink control channel resource, or a combination of these. The control signaling may also include DCI signaling corresponding to the BFR procedure, where the DCI signaling may include a downlink control channel in a recovery search space identifier, an uplink grant, or a control channel reception. The control signaling may also include a RAR message, a MAC-CE signal, or a combination of these.

At 310, UE 115-b may perform a downlink BFR procedure based on a downlink beam failure of a downlink beam of UE 115-b. In some cases, UE 115-b may transmit signaling indicating a capability of UE 115-b to reconfigure the uplink beam based on the configuration and the downlink BFR procedure.

At 315, base station 105-b may identify a downlink BFR procedure performed by UE 115-b based on a downlink BFR of a downlink beam of UE 115-b.

At 320, UE 115-b may reconfigure an uplink beam based on the configuration and the downlink BFR procedure. The reconfiguration may include maintaining a selected uplink beam, changing the uplink beam, maintaining power control parameters of the uplink beam, or changing power control parameters of the uplink beam. UE 115-b may reconfigure the uplink beam based on a rule indicated by the configuration. The rule indicated by the configuration may indicate whether to reset the uplink beam based on a random access channel transmission beam used in the downlink BFR procedure.

In one case, UE 115-b may determine that the uplink beam corresponds to a downlink reference signal associated with the detected downlink beam failure. UE 115-b may the reset the uplink beam (e.g., change the uplink beam). For example, UE 115-b may rest the uplink beam to a beam used for a previous random access transmission. In another example, UE 115-b may reset the uplink beam to a new candidate beam.

In another case, UE 115-b may determine that the uplink beam corresponds to a particular uplink reference signal. In these cases, UE 115-b may maintain the uplink beam for uplink control channel transmissions after performing the downlink BFR recovery procedure based on the rule. For example, UE 115-b may use the same uplink beam as previously used.

In some cases, UE 115-b may receive an indication of a path loss threshold. UE 115-b may identify a candidate beam for the uplink beam based on the downlink BFR procedure. UE 115-b may determine that a path loss measurement of the candidate beam exceeds the path loss threshold. UE 115-b may then maintain the uplink beam for uplink control channel transmissions after performing the downlink BFR procedure based on the rule.

UE 115-b may also identify a candidate beam for the uplink beam based on the downlink BFR procedure. UE 115-b may determine that a path loss measurement of the candidate beam fails to satisfy the path loss threshold. UE 115-b may then reset the uplink beam to the candidate beam based on the rule.

Additionally or alternatively, the rule indicated by the configuration may indicate whether the US is to reconfigure an uplink power control configuration of the uplink beam, an uplink path loss value of the uplink beam, or both. In these cases, UE 115-b may determine that the uplink path loss value may be based on path loss reference signal measurements corresponding to a path loss reference signal identifier corresponding to the uplink beam. UE 115-b may reset the uplink path loss value based on a path loss value corresponding to a new candidate beam.

In some cases, UE 115-b may also adjust a TPC command of the uplink beam. UE 115-b may receive signaling indicating the TPC command, where the signaling may includes DCI or a RAR message. UE 115-b may also determine whether to adjust a delta power ramp-up parameter corresponding to the TPC command. UE 115-b may determine whether a random access transmission is transmitted using a receive beam corresponding to a new candidate beam, where determining whether to adjust the delta power ramp-up parameter may be based on the random access transmission.

At 325, UE 115-b may transmit an uplink control channel (e.g., a PUCCH_transmission using the uplink beam selected. Base station 105-b may receive the uplink control channel signaling from UE 115-b based on the configuration and the downlink BFR procedure.

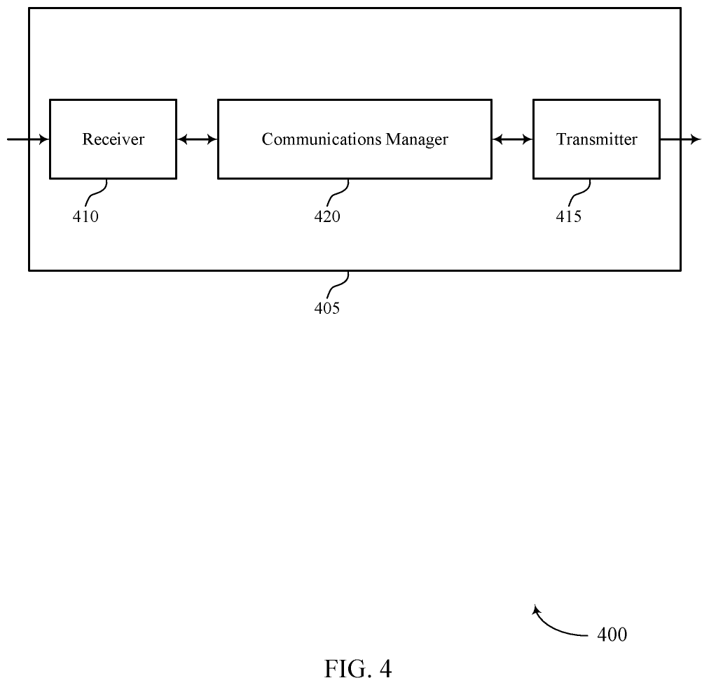

FIG. 4 shows a block diagram 400 of a device 405 that supports uplink beam continuation for downlink BFR in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to uplink beam continuation for downlink BFR). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to uplink beam continuation for downlink BFR). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of uplink beam continuation for downlink BFR as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

For example, the communications manager 420 may be configured as or otherwise support a means for receiving control signaling indicating a configuration for uplink beam management for use in response to a downlink beam failure detection in a deployment configuration where uplink beams of the UE are decoupled from downlink beams of the UE. The communications manager 420 may be configured as or otherwise support a means for performing a downlink BFR procedure based on a downlink beam failure of a downlink beam of the UE. The communications manager 420 may be configured as or otherwise support a means for reconfiguring an uplink beam based on the configuration and the downlink BFR procedure.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for device 405 to improve communications efficiency by selectively updating beams, rather than updating all beams upon a beam failure of one type of beam.

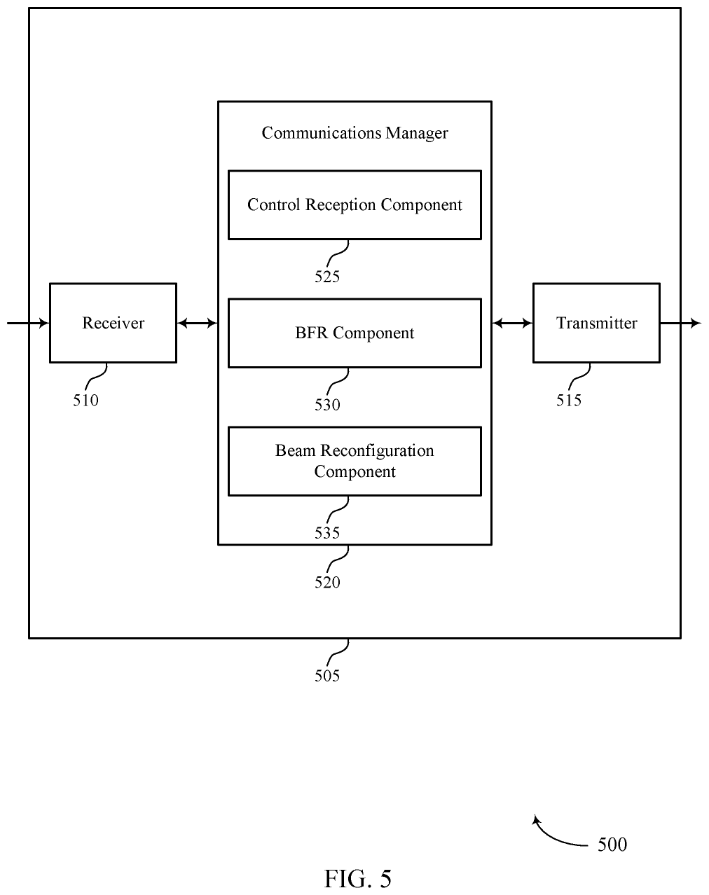

FIG. 5 shows a block diagram 500 of a device 505 that supports uplink beam continuation for downlink BFR in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink beam continuation for downlink BFR). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink beam continuation for downlink BFR). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of uplink beam continuation for downlink BFR as described herein. For example, the communications manager 520 may include a control reception component 525, an BFR component 530, a beam reconfiguration component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The control reception component 525 may be configured as or otherwise support a means for receiving control signaling indicating a configuration for uplink beam management for use in response to a downlink beam failure detection in a deployment configuration where uplink beams of the UE are decoupled from downlink beams of the UE. The BFR component 530 may be configured as or otherwise support a means for performing a downlink BFR procedure based on a downlink beam failure of a downlink beam of the UE. The beam reconfiguration component 535 may be configured as or otherwise support a means for reconfiguring an uplink beam based on the configuration and the downlink BFR procedure.

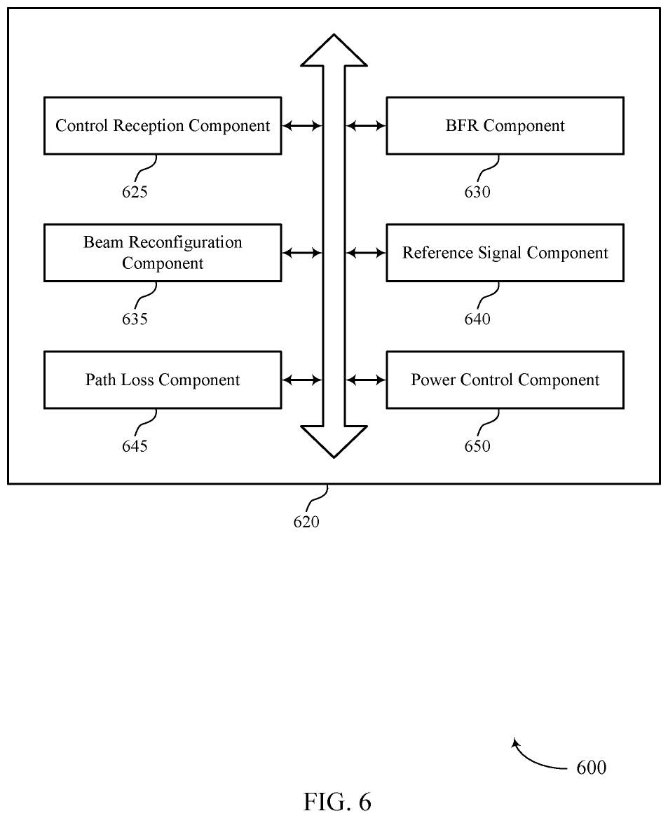

FIG. 6 shows a block diagram 600 of a communications manager 620 that supports uplink beam continuation for downlink BFR in accordance with aspects of the present disclosure. The communications manager 620 may be an example of aspects of a communications manager 420, a communications manager 520, or both, as described herein. The communications manager 620, or various components thereof, may be an example of means for performing various aspects of uplink beam continuation for downlink BFR as described herein. For example, the communications manager 620 may include a control reception component 625, an BFR component 630, a beam reconfiguration component 635, a reference signal component 640, a path loss component 645, a power control component 650, or any combination thereof. Each of these components may communicate, directly or indirectly, with one another (e.g., via one or more buses).

The control reception component 625 may be configured as or otherwise support a means for receiving control signaling indicating a configuration for uplink beam management for use in response to a downlink beam failure detection in a deployment configuration where uplink beams of the UE are decoupled from downlink beams of the UE. The BFR component 630 may be configured as or otherwise support a means for performing a downlink BFR procedure based on a downlink beam failure of a downlink beam of the UE. The beam reconfiguration component 635 may be configured as or otherwise support a means for reconfiguring an uplink beam based on the configuration and the downlink BFR procedure.

In some examples, the beam reconfiguration component 635 may be configured as or otherwise support a means for reconfiguring the uplink beam based on a rule indicated by the configuration.

In some examples, the reference signal component 640 may be configured as or otherwise support a means for determining that the uplink beam corresponds to a downlink reference signal associated with the detected downlink beam failure. In some examples, the beam reconfiguration component 635 may be configured as or otherwise support a means for resetting the uplink beam based on the determining and the rule.

In some examples, the beam reconfiguration component 635 may be configured as or otherwise support a means for resetting the uplink beam to a beam used for a previous random access transmission.

In some examples, the beam reconfiguration component 635 may be configured as or otherwise support a means for resetting the uplink beam to a new candidate beam.

In some examples, the reference signal component 640 may be configured as or otherwise support a means for determining that the uplink beam corresponds to an uplink reference signal. In some examples, the beam reconfiguration component 635 may be configured as or otherwise support a means for maintaining the uplink beam for uplink control channel transmissions after performing the downlink BFR procedure based on the determining and the rule.

In some examples, the rule indicated by the configuration indicates whether to reset the uplink beam based on a random access channel transmission beam used in the downlink BFR procedure.

In some examples, the path loss component 645 may be configured as or otherwise support a means for receiving an indication of a path loss threshold.

In some examples, the BFR component 630 may be configured as or otherwise support a means for identifying a candidate beam for the uplink beam based on the downlink BFR procedure. In some examples, the path loss component 645 may be configured as or otherwise support a means for determining that a path loss measurement of the candidate beam exceeds the path loss threshold. In some examples, the beam reconfiguration component 635 may be configured as or otherwise support a means for maintaining the uplink beam for uplink control channel transmissions after performing the downlink BFR procedure based on the determining and the rule.

In some examples, the BFR component 630 may be configured as or otherwise support a means for identifying a candidate beam for the uplink beam based on the downlink BFR procedure. In some examples, the path loss component 645 may be configured as or otherwise support a means for determining that a path loss measurement of the candidate beam fails to satisfy a path loss threshold. In some examples, the beam reconfiguration component 635 may be configured as or otherwise support a means for resetting the uplink beam to the candidate beam based on the determining and the rule.

In some examples, the rule indicates whether the UE is to reconfigure an uplink power control configuration of the uplink beam, an uplink path loss value of the uplink beam, or both.

In some examples, the path loss component 645 may be configured as or otherwise support a means for determining that the uplink path loss value is based on path loss reference signal measurements corresponding to a path loss reference signal identifier corresponding to the uplink beam. In some examples, the beam reconfiguration component 635 may be configured as or otherwise support a means for resetting the uplink path loss value based on a path loss value corresponding to a new candidate beam.

In some examples, the power control component 650 may be configured as or otherwise support a means for adjusting a TPC command of the uplink beam.

In some examples, the power control component 650 may be configured as or otherwise support a means for receiving signaling indicating the TPC command, where the signaling includes DCI or a RAR message.

In some examples, to support adjusting the TPC command, the power control component 650 may be configured as or otherwise support a means for determining whether to adjust a delta power ramp-up parameter corresponding to the TPC command.

In some examples, the power control component 650 may be configured as or otherwise support a means for determining whether a random access transmission is transmitted using a receive beam corresponding to a new candidate beam, where determining whether to adjust the delta power ramp-up parameter is based on the random access transmission.

In some examples, the control signaling indicating the configuration for the uplink beam management includes RRC signaling corresponding to a serving cell configuration, a BWP configuration, a BFR configuration, an uplink control channel resource, or a combination thereof.

In some examples, the control signaling indicating the configuration for the uplink beam management includes DCI signaling corresponding to the downlink BFR procedure. In some examples, the DCI information includes a downlink control channel in a recovery search space identifier, an uplink grant, or a control channel reception.

In some examples, the control signaling indicating the configuration for the uplink beam management includes a RAR message, a medium access control channel element signal, or a combination thereof.

In some examples, the beam reconfiguration component 635 may be configured as or otherwise support a means for transmitting signaling indicating a capability of the UE to reconfigure the uplink beam based on the configuration and the downlink BFR procedure.

In some examples, the beam reconfiguration component 635 may be configured as or otherwise support a means for transmitting an uplink control channel transmission using the uplink beam.

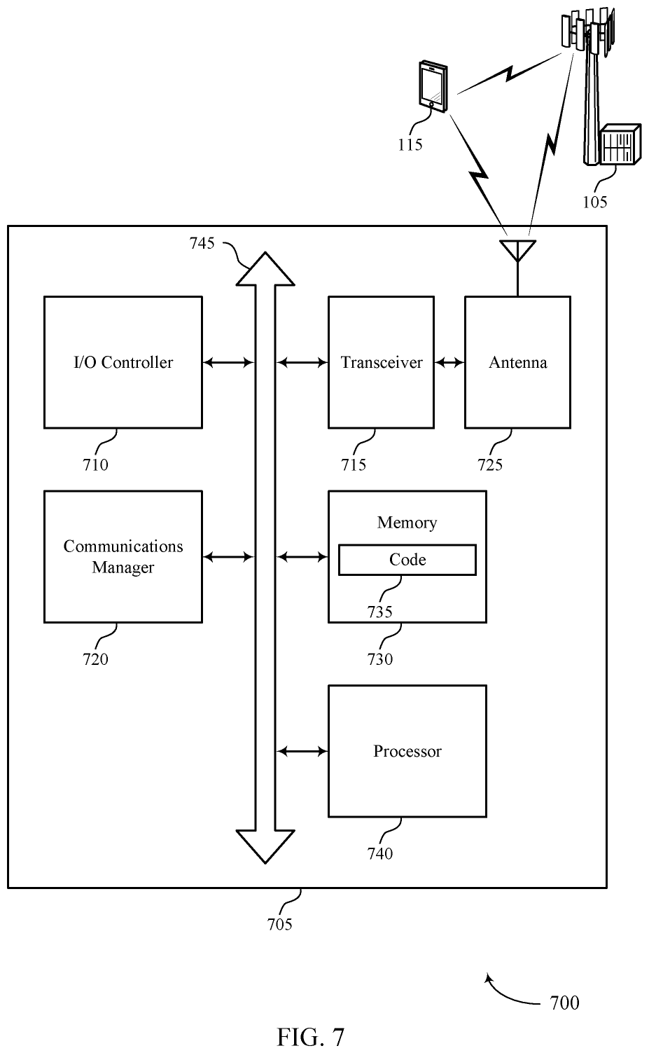

FIG. 7 shows a diagram of a system 700 including a device 705 that supports uplink beam continuation for downlink BFR in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting uplink beam continuation for downlink BFR). For example, the device 705 or a component of the device 705 may include a processor 740 and memory 730 coupled to the processor 740, the processor 740 and memory 730 configured to perform various functions described herein.

For example, the communications manager 720 may be configured as or otherwise support a means for receiving control signaling indicating a configuration for uplink beam management for use in response to a downlink beam failure detection in a deployment configuration where uplink beams of the UE are decoupled from downlink beams of the UE. The communications manager 720 may be configured as or otherwise support a means for performing a downlink BFR procedure based on a downlink beam failure of a downlink beam of the UE. The communications manager 720 may be configured as or otherwise support a means for reconfiguring an uplink beam based on the configuration and the downlink BFR procedure.

By including or configuring the communications manager 720 in accordance with examples as described herein, the device 705 may support techniques for improved communications reliability by maintaining high quality beams, rather than changing uplink and downlink beams in response to a downlink beam failure.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of uplink beam continuation for downlink BFR as described herein, or the processor 740 and the memory 730 may be otherwise configured to perform or support such operations.

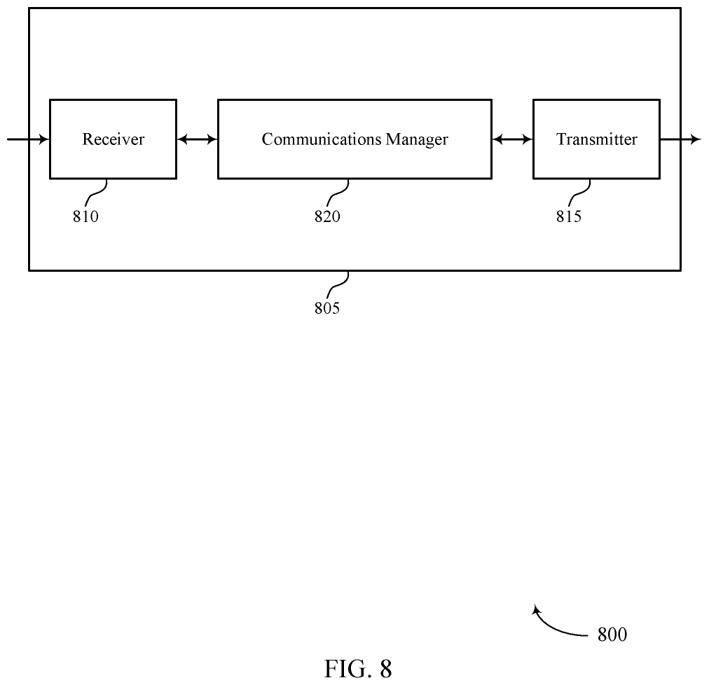

FIG. 8 shows a block diagram 800 of a device 805 that supports uplink beam continuation for downlink BFR in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to uplink beam continuation for downlink BFR). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to uplink beam continuation for downlink BFR). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of uplink beam continuation for downlink BFR as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

For example, the communications manager 820 may be configured as or otherwise support a means for transmitting, to a UE, control signaling indicating a configuration for uplink beam management for use in response to a downlink beam failure detection in a deployment configuration where uplink beams of the UE are decoupled from downlink beams of the UE. The communications manager 820 may be configured as or otherwise support a means for identifying a downlink BFR procedure based on a downlink beam failure of a downlink beam of the UE. The communications manager 820 may be configured as or otherwise support a means for receiving an uplink signal from the UE on an uplink beam based on the configuration and the downlink BFR procedure.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced power consumption and increased communications efficiency and accuracy by providing configuration signaling indicating for other devices to change beams based on beam quality and direction rather than updating uplink and downlink beams based on a beam failure of a downlink beam.

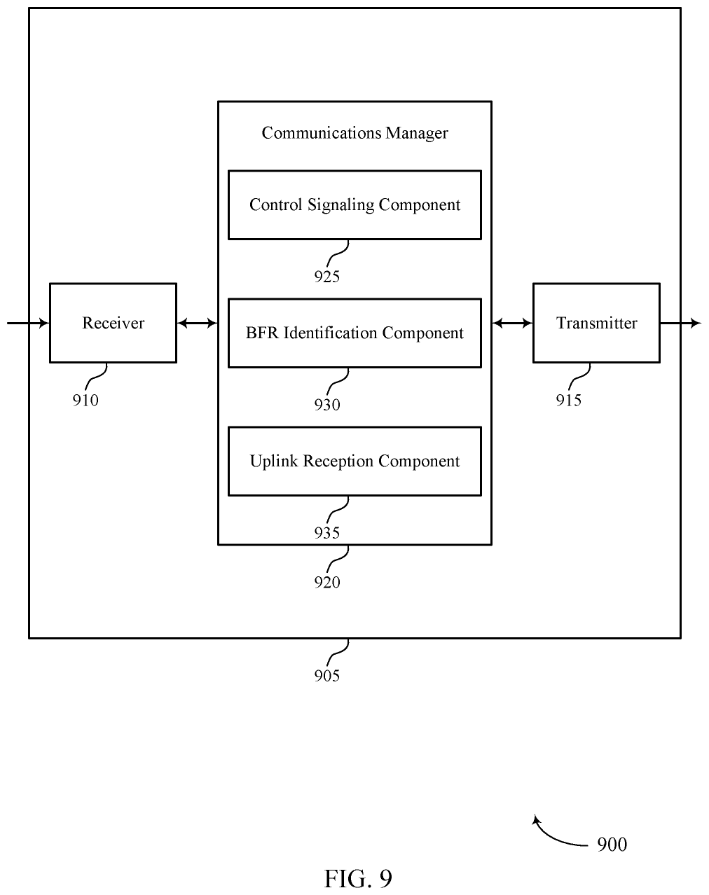

FIG. 9 shows a block diagram 900 of a device 905 that supports uplink beam continuation for downlink BFR in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to uplink beam continuation for downlink BFR). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to uplink beam continuation for downlink BFR). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of uplink beam continuation for downlink BFR as described herein. For example, the communications manager 920 may include a control signaling component 925, an BFR identification component 930, an uplink reception component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The control signaling component 925 may be configured as or otherwise support a means for transmitting, to a UE, control signaling indicating a configuration for uplink beam management for use in response to a downlink beam failure detection in a deployment configuration where uplink beams of the UE are decoupled from downlink beams of the UE. The BFR identification component 930 may be configured as or otherwise support a means for identifying a downlink BFR procedure based on a downlink beam failure of a downlink beam of the UE. The uplink reception component 935 may be configured as or otherwise support a means for receiving an uplink signal from the UE on an uplink beam based on the configuration and the downlink BFR procedure.

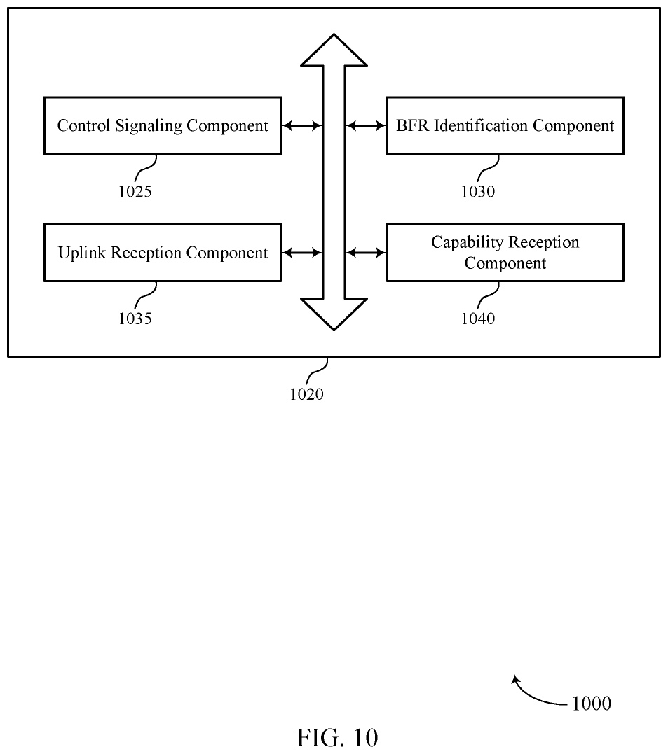

FIG. 10 shows a block diagram 1000 of a communications manager 1020 that supports uplink beam continuation for downlink BFR in accordance with aspects of the present disclosure. The communications manager 1020 may be an example of aspects of a communications manager 820, a communications manager 920, or both, as described herein. The communications manager 1020, or various components thereof, may be an example of means for performing various aspects of uplink beam continuation for downlink BFR as described herein. For example, the communications manager 1020 may include a control signaling component 1025, an BFR identification component 1030, an uplink reception component 1035, a capability reception component 1040, or any combination thereof. Each of these components may communicate, directly or indirectly, with one another (e.g., via one or more buses).

The control signaling component 1025 may be configured as or otherwise support a means for transmitting, to a UE, control signaling indicating a configuration for uplink beam management for use in response to a downlink beam failure detection in a deployment configuration where uplink beams of the UE are decoupled from downlink beams of the UE. The BFR identification component 1030 may be configured as or otherwise support a means for identifying a downlink BFR procedure based on a downlink beam failure of a downlink beam of the UE. The uplink reception component 1035 may be configured as or otherwise support a means for receiving an uplink signal from the UE on an uplink beam based on the configuration and the downlink BFR procedure.

In some examples, the uplink reception component 1035 may be configured as or otherwise support a means for receiving the uplink signal from the UE, where the uplink signal is transmitted using a new candidate beam of the UE.

In some examples, the uplink reception component 1035 may be configured as or otherwise support a means for receiving the uplink signal from the UE, where the uplink signal is transmitted using a beam used for a previous random access transmission of the UE.

In some examples, the capability reception component 1040 may be configured as or otherwise support a means for receiving signaling indicating a capability of the UE to reconfigure the uplink beam based on the configuration and a downlink BFR procedure.

In some examples, the uplink reception component 1035 may be configured as or otherwise support a means for receiving an uplink control channel transmission from the UE using the uplink beam.

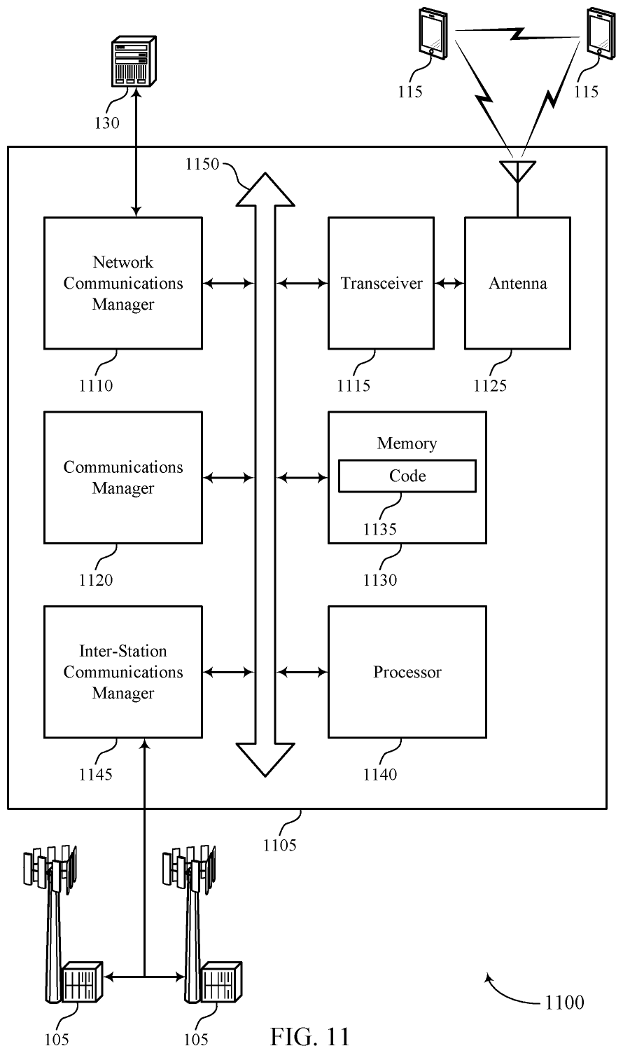

FIG. 11 shows a diagram of a system 1100 including a device 1105 that supports uplink beam continuation for downlink BFR in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting uplink beam continuation for downlink BFR). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

For example, the communications manager 1120 may be configured as or otherwise support a means for transmitting, to a UE, control signaling indicating a configuration for uplink beam management for use in response to a downlink beam failure detection in a deployment configuration where uplink beams of the UE are decoupled from downlink beams of the UE. The communications manager 1120 may be configured as or otherwise support a means for identifying a downlink BFR procedure based on a downlink beam failure of a downlink beam of the UE. The communications manager 1120 may be configured as or otherwise support a means for receiving an uplink signal from the UE on an uplink beam based on the configuration and the downlink BFR procedure.

By including or configuring the communications manager 1120 in accordance with examples as described herein, the device 1105 may support techniques for improved communications reliability by providing configuration information and rules for devices to maintain quality beams rather than requiring devices to update uplink and downlink beams upon a downlink beam failure, particularly in uplink dense communications scenarios.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of uplink beam continuation for downlink BFR as described herein, or the processor 1140 and the memory 1130 may be otherwise configured to perform or support such operations.

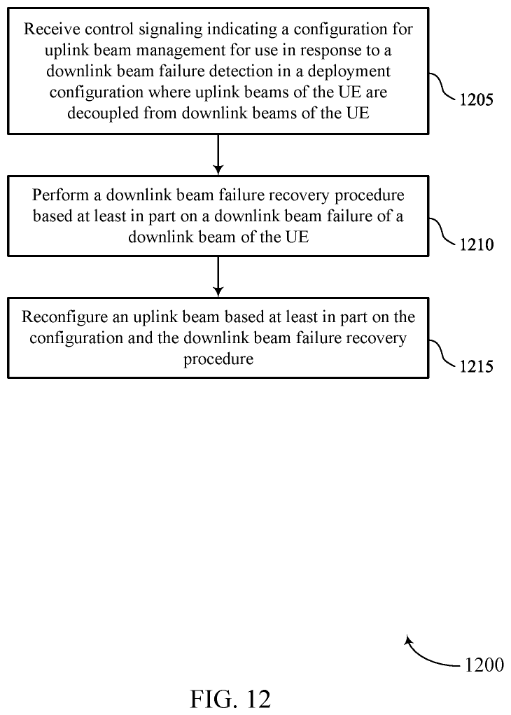

FIG. 12 shows a flowchart illustrating a method 1200 that supports uplink beam continuation for downlink BFR in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving control signaling indicating a configuration for uplink beam management for use in response to a downlink beam failure detection in a deployment configuration where uplink beams of the UE are decoupled from downlink beams of the UE. The operations of 1205 may be performed in accordance with examples as disclosed herein. In some examples, aspects of the operations of 1205 may be performed by a control reception component 625 as described with reference to FIG. 6.

At 1210, the method may include performing a downlink BFR procedure based on a downlink beam failure of a downlink beam of the UE. The operations of 1210 may be performed in accordance with examples as disclosed herein. In some examples, aspects of the operations of 1210 may be performed by an BFR component 630 as described with reference to FIG. 6.

At 1215, the method may include reconfiguring an uplink beam based on the configuration and the downlink BFR procedure. The operations of 1215 may be performed in accordance with examples as disclosed herein. In some examples, aspects of the operations of 1215 may be performed by a beam reconfiguration component 635 as described with reference to FIG. 6.

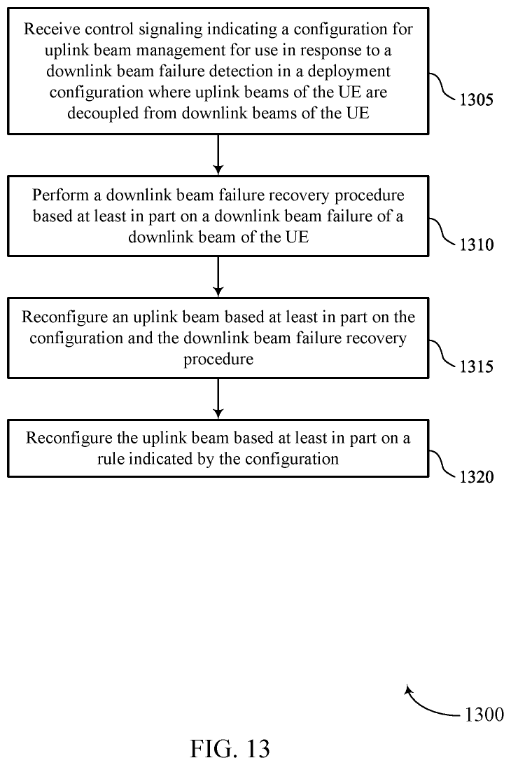

FIG. 13 shows a flowchart illustrating a method 1300 that supports uplink beam continuation for downlink BFR in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving control signaling indicating a configuration for uplink beam management for use in response to a downlink beam failure detection in a deployment configuration where uplink beams of the UE are decoupled from downlink beams of the UE. The operations of 1305 may be performed in accordance with examples as disclosed herein. In some examples, aspects of the operations of 1305 may be performed by a control reception component 625 as described with reference to FIG. 6.

At 1310, the method may include performing a downlink BFR procedure based on a downlink beam failure of a downlink beam of the UE. The operations of 1310 may be performed in accordance with examples as disclosed herein. In some examples, aspects of the operations of 1310 may be performed by an BFR component 630 as described with reference to FIG. 6.

At 1315, the method may include reconfiguring an uplink beam based on the configuration and the downlink BFR procedure. The operations of 1315 may be performed in accordance with examples as disclosed herein. In some examples, aspects of the operations of 1315 may be performed by a beam reconfiguration component 635 as described with reference to FIG. 6.

At 1320, the method may include reconfiguring the uplink beam based on a rule indicated by the configuration. The operations of 1320 may be performed in accordance with examples as disclosed herein. In some examples, aspects of the operations of 1320 may be performed by a beam reconfiguration component 635 as described with reference to FIG. 6.

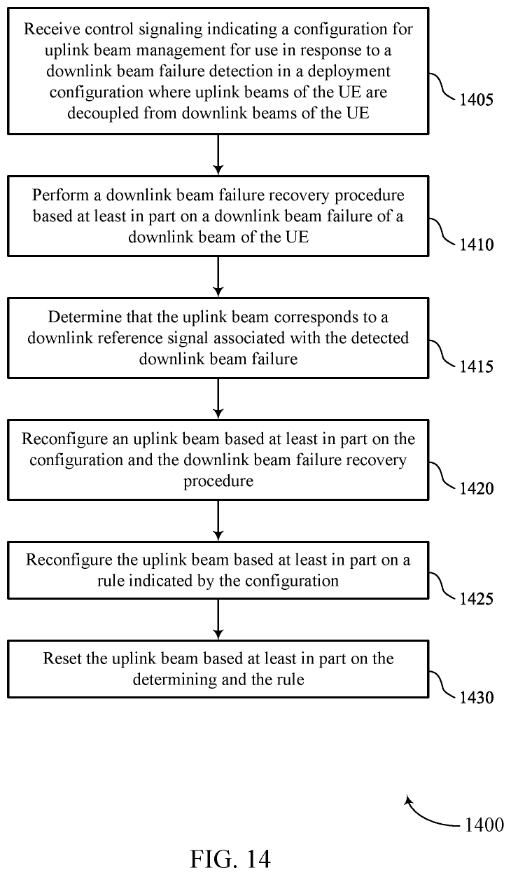

FIG. 14 shows a flowchart illustrating a method 1400 that supports uplink beam continuation for downlink BFR in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving control signaling indicating a configuration for uplink beam management for use in response to a downlink beam failure detection in a deployment configuration where uplink beams of the UE are decoupled from downlink beams of the UE. The operations of 1405 may be performed in accordance with examples as disclosed herein. In some examples, aspects of the operations of 1405 may be performed by a control reception component 625 as described with reference to FIG. 6.

At 1410, the method may include performing a downlink BFR procedure based on a downlink beam failure of a downlink beam of the UE. The operations of 1410 may be performed in accordance with examples as disclosed herein. In some examples, aspects of the operations of 1410 may be performed by an BFR component 630 as described with reference to FIG. 6.

At 1415, the method may include determining that the uplink beam corresponds to a downlink reference signal associated with the detected downlink beam failure. The operations of 1415 may be performed in accordance with examples as disclosed herein. In some examples, aspects of the operations of 1415 may be performed by a reference signal component 640 as described with reference to FIG. 6.

At 1420, the method may include reconfiguring an uplink beam based on the configuration and the downlink BFR procedure. The operations of 1420 may be performed in accordance with examples as disclosed herein. In some examples, aspects of the operations of 1420 may be performed by a beam reconfiguration component 635 as described with reference to FIG. 6.

At 1425, the method may include reconfiguring the uplink beam based on a rule indicated by the configuration. The operations of 1425 may be performed in accordance with examples as disclosed herein. In some examples, aspects of the operations of 1425 may be performed by a beam reconfiguration component 635 as described with reference to FIG. 6.

At 1430, the method may include resetting the uplink beam based on the determining and the rule. The operations of 1430 may be performed in accordance with examples as disclosed herein. In some examples, aspects of the operations of 1430 may be performed by a beam reconfiguration component 635 as described with reference to FIG. 6.

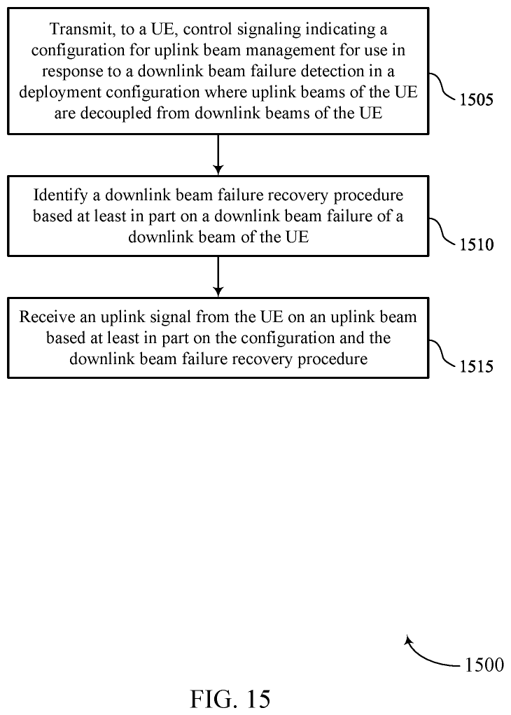

FIG. 15 shows a flowchart illustrating a method 1500 that supports uplink beam continuation for downlink BFR in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling indicating a configuration for uplink beam management for use in response to a downlink beam failure detection in a deployment configuration where uplink beams of the UE are decoupled from downlink beams of the UE. The operations of 1505 may be performed in accordance with examples as disclosed herein. In some examples, aspects of the operations of 1505 may be performed by a control signaling component 1025 as described with reference to FIG. 10.

At 1510, the method may include identifying a downlink BFR procedure based on a downlink beam failure of a downlink beam of the UE. The operations of 1510 may be performed in accordance with examples as disclosed herein. In some examples, aspects of the operations of 1510 may be performed by an BFR identification component 1030 as described with reference to FIG. 10.

At 1515, the method may include receiving an uplink signal from the UE on an uplink beam based on the configuration and the downlink BFR procedure. The operations of 1515 may be performed in accordance with examples as disclosed herein. In some examples, aspects of the operations of 1515 may be performed by an uplink reception component 1035 as described with reference to FIG. 10.

The following provides an overview of aspects of the present disclosure:

Aspect 1: A method of wireless communications at a UE, comprising: receiving control signaling indicating a configuration for uplink beam management for use in response to a downlink beam failure detection in a deployment configuration where uplink beams of the UE are decoupled from downlink beams of the UE; performing a downlink BFR procedure based at least in part on a downlink beam failure of a downlink beam of the UE; and reconfiguring an uplink beam based at least in part on the configuration and the downlink BFR procedure.

Aspect 2: The method of aspect 1, further comprising: reconfiguring the uplink beam based at least in part on a rule indicated by the configuration.

Aspect 3: The method of aspect 2, further comprising: determining that the uplink beam corresponds to a downlink reference signal associated with the detected downlink beam failure; and resetting the uplink beam based at least in part on the determining and the rule.

Aspect 4: The method of aspect 3, further comprising: resetting the uplink beam to a beam used for a previous random access transmission.

Aspect 5: The method of any of aspects 3 through 4, further comprising: resetting the uplink beam to a new candidate beam.

Aspect 6: The method of any of aspects 2 through 5, further comprising: determining that the uplink beam corresponds to an uplink reference signal; and maintaining the uplink beam for uplink control channel transmissions after performing the downlink BFR procedure based at least in part on the determining and the rule.

Aspect 7: The method of any of aspects 2 through 6, wherein the rule indicated by the configuration indicates whether to reset the uplink beam based at least in part on a random access channel transmission beam used in the downlink BFR procedure.

Aspect 8: The method of any of aspects 2 through 7, further comprising: receiving an indication of a path loss threshold.

Aspect 9: The method of aspect 8, further comprising: identifying a candidate beam for the uplink beam based at least in part on the downlink BFR procedure; determining that a path loss measurement of the candidate beam exceeds the path loss threshold; and maintaining the uplink beam for uplink control channel transmissions after performing the downlink BFR procedure based at least in part on the determining and the rule.

Aspect 10: The method of any of aspects 2 through 9, further comprising: identifying a candidate beam for the uplink beam based at least in part on the downlink BFR procedure; determining that a path loss measurement of the candidate beam fails to satisfy a path loss threshold; and resetting the uplink beam to the candidate beam based at least in part on the determining and the rule.

Aspect 11: The method of any of aspects 2 through 10, wherein the rule indicates whether the UE is to reconfigure an uplink power control configuration of the uplink beam, an uplink path loss value of the uplink beam, or both.

Aspect 12: The method of aspect 11, further comprising: determining that the uplink path loss value is based at least in part on path loss reference signal measurements corresponding to a path loss reference signal identifier corresponding to the uplink beam; and resetting the uplink path loss value based at least in part on a path loss value corresponding to a new candidate beam.

Aspect 13: The method of any of aspects 11 through 12, further comprising: adjusting a TPC command of the uplink beam.

Aspect 14: The method of aspect 13, further comprising: receiving signaling indicating the TPC command, wherein the signaling comprises downlink control information or a random access response message.

Aspect 15: The method of any of aspects 13 through 14, wherein adjusting the TPC command comprises: determining whether to adjust a delta power ramp-up parameter corresponding to the TPC command.

Aspect 16: The method of aspect 15, further comprising: determining whether a random access transmission is transmitted using a receive beam corresponding to a new candidate beam, wherein determining whether to adjust the delta power ramp-up parameter is based at least in part on the random access transmission.

Aspect 17: The method of any of aspects 1 through 16, wherein the control signaling indicating the configuration for the uplink beam management comprises RRC signaling corresponding to a serving cell configuration, a bandwidth part configuration, a BFR configuration, an uplink control channel resource, or a combination thereof.

Aspect 18: The method of any of aspects 1 through 17, wherein the control signaling indicating the configuration for the uplink beam management comprises downlink control information signaling corresponding to the downlink BFR procedure, the downlink control information comprises a downlink control channel in a recovery search space identifier, an uplink grant, or a control channel reception.

Aspect 19: The method of any of aspects 1 through 18, wherein the control signaling indicating the configuration for the uplink beam management comprises a random access response message, a medium access control channel element signal, or a combination thereof.

Aspect 20: The method of any of aspects 1 through 19, further comprising: transmitting signaling indicating a capability of the UE to reconfigure the uplink beam based at least in part on the configuration and the downlink BFR procedure.

Aspect 21: The method of any of aspects 1 through 20, further comprising: transmitting an uplink control channel transmission using the uplink beam.

Aspect 22: A method of wireless communications at a base station, comprising: transmitting, to a UE, control signaling indicating a configuration for uplink beam management for use in response to a downlink beam failure detection in a deployment configuration where uplink beams of the UE are decoupled from downlink beams of the UE; identifying a downlink BFR procedure based at least in part on a downlink beam failure of a downlink beam of the UE; and receiving an uplink signal from the UE on an uplink beam based at least in part on the configuration and the downlink BFR procedure.

Aspect 23: The method of aspect 22, further comprising: receiving the uplink signal from the UE, wherein the uplink signal is transmitted using a new candidate beam of the UE.

Aspect 24: The method of any of aspects 22 through 23, further comprising: receiving the uplink signal from the UE, wherein the uplink signal is transmitted using a beam used for a previous random access transmission of the UE.

Aspect 25: The method of any of aspects 22 through 24, further comprising: receiving signaling indicating a capability of the UE to reconfigure the uplink beam based at least in part on the configuration and a downlink BFR procedure.

Aspect 26: The method of any of aspects 22 through 25, further comprising: receiving an uplink control channel transmission from the UE using the uplink beam.

Aspect 27: An apparatus comprising a processor; memory coupled with the processor; and instructions stored in the memory and executable by the processor to cause the apparatus to perform a method of any of aspects 1 through 21.

Aspect 28: An apparatus comprising at least one means for performing a method of any of aspects 1 through 21.

Aspect 29: A non-transitory computer-readable medium storing code the code comprising instructions executable by a processor to perform a method of any of aspects 1 through 21.

Aspect 30: An apparatus comprising a processor; memory coupled with the processor; and instructions stored in the memory and executable by the processor to cause the apparatus to perform a method of any of aspects 22 through 26.

Aspect 31: An apparatus comprising at least one means for performing a method of any of aspects 22 through 26.

Aspect 32: A non-transitory computer-readable medium storing code the code comprising instructions executable by a processor to perform a method of any of aspects 22 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method of wireless communications at a user equipment (UE), comprising:
receiving control signaling indicating a configuration for uplink beam management for use in response to a downlink beam failure detection in a deployment configuration where uplink beams of the UE are decoupled from downlink beams of the UE;
performing a downlink beam failure recovery procedure based at least in part on a downlink beam failure of a downlink beam of the UE; and
reconfiguring an uplink beam based at least in part on the configuration and the downlink beam failure recovery procedure.

2. The method of claim 1, further comprising:
reconfiguring the uplink beam based at least in part on a rule indicated by the configuration.

3. The method of claim 2, further comprising:
determining that the uplink beam corresponds to a downlink reference signal associated with the detected downlink beam failure; and
resetting the uplink beam based at least in part on the determining and the rule.

4. The method of claim 3, further comprising:
resetting the uplink beam to a beam used for a previous random access transmission.

5. The method of claim 3, further comprising:
resetting the uplink beam to a new candidate beam.

6. The method of claim 2, further comprising:
determining that the uplink beam corresponds to an uplink reference signal; and
maintaining the uplink beam for uplink control channel transmissions after performing the downlink beam failure recovery procedure based at least in part on the determining and the rule.

7. The method of claim 2, wherein the rule indicated by the configuration indicates whether to reset the uplink beam based at least in part on a random access channel transmission beam used in the downlink beam failure recovery procedure.

8. The method of claim 2, further comprising:
receiving an indication of a path loss threshold.

9. The method of claim 8, further comprising:
identifying a candidate beam for the uplink beam based at least in part on the downlink beam failure recovery procedure;
determining that a path loss measurement of the candidate beam exceeds the path loss threshold; and
maintaining the uplink beam for uplink control channel transmissions after performing the downlink beam failure recovery procedure based at least in part on the determining and the rule.

10. The method of claim 8, further comprising:
identifying a candidate beam for the uplink beam based at least in part on the downlink beam failure recovery procedure;
determining that a path loss measurement of the candidate beam fails to satisfy the path loss threshold; and
resetting the uplink beam to the candidate beam based at least in part on the determining and the rule.

11. The method of claim 2, wherein the rule indicates whether the UE is to reconfigure an uplink power control configuration of the uplink beam, an uplink path loss value of the uplink beam, or both.

12. The method of claim 11, further comprising:
determining that the uplink path loss value is based at least in part on path loss reference signal measurements corresponding to a path loss reference signal identifier corresponding to the uplink beam; and
resetting the uplink path loss value based at least in part on a path loss value corresponding to a new candidate beam.

13. The method of claim 11, further comprising:
adjusting a transmit power control command of the uplink beam.

14. The method of claim 13, further comprising:
receiving signaling indicating the transmit power control command, wherein the signaling comprises downlink control information or a random access response message.

15. The method of claim 13, wherein adjusting the transmit power control command comprises:
determining whether to adjust a delta power ramp-up parameter corresponding to the transmit power control command.

16. The method of claim 15, further comprising:
determining whether a random access transmission is transmitted using a receive beam corresponding to a new candidate beam, wherein determining whether to adjust the delta power ramp-up parameter is based at least in part on the random access transmission.

17. The method of claim 1, wherein the control signaling indicating the configuration for the uplink beam management comprises radio resource control signaling corresponding to a serving cell configuration, a bandwidth part configuration, a beam failure recovery configuration, an uplink control channel resource, or a combination thereof.

18. The method of claim 1, wherein the control signaling indicating the configuration for the uplink beam management comprises downlink control information signaling corresponding to the downlink beam failure recovery procedure, wherein the downlink control information signaling comprises a downlink control channel in a recovery search space identifier, an uplink grant, or a control channel reception.

19. The method of claim 1, wherein the control signaling indicating the configuration for the uplink beam management comprises a random access response message, a medium access control channel element signal, or a combination thereof.

20. The method of claim 1, further comprising:
transmitting signaling indicating a capability of the UE to reconfigure the uplink beam based at least in part on the configuration and the downlink beam failure recovery procedure.

21. The method of claim 1, further comprising:
transmitting an uplink control channel transmission using the uplink beam.

22. A method of wireless communications at a base station, comprising:
transmitting, to a user equipment (UE), control signaling indicating a configuration for uplink beam management for use in response to a downlink beam failure detection in a deployment configuration where uplink beams of the UE are decoupled from downlink beams of the UE;
identifying a downlink beam failure recovery procedure based at least in part on a downlink beam failure of a downlink beam of the UE; and
receiving an uplink signal from the UE on an uplink beam based at least in part on the configuration and the downlink beam failure recovery procedure.

23. The method of claim 22, further comprising:
receiving the uplink signal from the UE, wherein the uplink signal is transmitted using a new candidate beam of the UE.

24. The method of claim 22, further comprising:
receiving the uplink signal from the UE, wherein the uplink signal is transmitted using a beam used for a previous random access transmission of the UE.

25. The method of claim 22, further comprising:
receiving signaling indicating a capability of the UE to reconfigure the uplink beam based at least in part on the configuration and a downlink beam failure recovery procedure.

26. The method of claim 22, further comprising:
receiving an uplink control channel transmission from the UE using the uplink beam.

27. An apparatus, comprising:
a processor;
memory coupled with the processor; and
instructions stored in the memory and executable by the processor to cause the apparatus to:
receive control signaling indicating a configuration for uplink beam management for use in response to a downlink beam failure detection in a deployment configuration where uplink beams of the UE are decoupled from downlink beams of the UE;
perform a downlink beam failure recovery procedure based at least in part on a downlink beam failure of a downlink beam of the UE; and
reconfigure an uplink beam based at least in part on the configuration and the downlink beam failure recovery procedure.

28. The apparatus of claim 27, wherein the instructions are further executable by the processor to cause the apparatus to:
reconfigure the uplink beam based at least in part on a rule indicated by the configuration.

29. The apparatus of claim 28, wherein the instructions are further executable by the processor to cause the apparatus to:
determine that the uplink beam corresponds to a downlink reference signal associated with the detected downlink beam failure; and
reset the uplink beam based at least in part on the determining and the rule.

30. An apparatus, comprising:
a processor;
memory coupled with the processor; and
instructions stored in the memory and executable by the processor to cause the apparatus to:
transmit, to a user equipment (UE), control signaling indicating a configuration for uplink beam management for use in response to a downlink beam failure detection in a deployment configuration where uplink beams of the UE are decoupled from downlink beams of the UE;
identify a downlink beam failure recovery procedure based at least in part on a downlink beam failure of a downlink beam of the UE; and
receive an uplink signal from the UE on an uplink beam based at least in part on the configuration and the downlink beam failure recovery procedure.
